(19) United States
(12) Patent Application Publication
(10) Pub. No.: US 2015/0033318 A1
(43) Pub. Date: Jan. 29, 2015

(54) METHOD AND SYSTEM FOR PROVIDING AT LEAST ONE DIGITAL OBJECT ON A DIGITAL LIBRARY MANAGER

(71) Applicant: ORANGE, Paris (FR)

(72) Inventors: Vincent Auvray, Tonneville (FR); Thierry Leclercq, Paris (FR)

(21) Appl. No.: 14/376,196

(22) PCT Filed: Jan. 28, 2013
(86) PCT No.: PCT/FR2013/050171

§ 371 Date: Aug. 1, 2014

(30) Foreign Application Priority Data
Feb. 1, 2012 (FR) 1250958

(51) Int. Cl. H04L 9/32

(52) U.S. Cl. CPC H04L 9/3268
USPC 726/10

(57) ABSTRACT

A method and system for providing at least one digital object to a user having a first digital reading device on which identification data, containing at least one piece of identification information related to the user, is locally stored, said method comprising: a step of generating, by means of a management server, the rights to read personal read rights data; a step of sending the personal read rights data to a personal digital library manager; and a step of authenticating the user by means of identification data.

The object of the invention relates to the field of digital object distribution, and more specifically to the field of providing at least one digital object to a user having a digital media consumption device such as, for example, a smartphone type of mobile phone, a computer, an e-book reader, a tablet computer, or any other type of multimedia support which allows viewing and/or playing the contents of a digital object.

The object of the invention advantageously enables the development of new services for providing digital objects; more generally, the object of the invention proposes a new approach to the distribution chain for digital content, in particular by expanding and enriching the offerings while maintaining the security of such content.

For the purposes of the invention, in the following description “digital object” is understood to mean any digital object containing digital information, for example such as multimedia digital information. As non-limiting examples, the digital objects in the sense of the invention may be digital content such as music, video, an e-book, software, an application, etc.

Currently, a large majority of systems for the distribution of digital objects consist of integrated and vertical systems: in this kind of system, the digital object distribution chain is controlled by a single party who manages the digital content from publishing to distribution.

Often, the parties in this growing market provide proprietary distribution systems in which the digital objects offered have their own file format readable only by a device which is also supplied by the distributor, which prevents the customer from accessing the object on devices other than the one provided for this purpose.

Such systems also pose problems in allowing third party access to the digital object.

For example, in the field of e-book distribution, when a consumer has chosen an e-book reader (a device for reading digital books) and has purchased one or more digital books, the device is linked to these books for the entire life of the books. If the consumer wants to change e-book readers, he or she could lose all the books so purchased; alternatively, if the consumer wants to access the contents of one of these books on another e-book reader, he or she may be unable to do so due to access control or file format issues.

Similarly, if a consumer buys two digital books from two independent suppliers, he or she may be unable to store these digital books in a single digital library.

There are other, more open, digital object distribution systems. In these systems, the role of the digital object distributor is distinct from that of the digital object seller. In such systems, it is the digital objects that are exchanged between distributors and sellers. Such systems therefore require a high level of interoperability between the different market players, particularly for the manufacturers of the digital media consumption devices and in the infrastructure of the distribution system or the format of the distributed files.

In addition, with such systems, there is the security issue for the digital objects that are exchanged and distributed. The market value of such digital objects usually leads to piracy activities.

Often, to avoid or at least limit this type of fraudulent activity, the distribution systems use files with digital rights management (DRM).

The principle of such digital rights management is based on the use of encrypted works combined with conditional access. The distributor using such access control issues a key for accessing the digital object, in exchange for a proof of purchase or a subscription.

Read access to the digital object is then only authorized for the device or the software identification certified by the supplier. Such access is cumbersome to manage, for both the distributor and the end user.

Indeed, integrating the security exclusively in DRM files creates problems when the user changes reading devices; such constraints also significantly hinder certain consumer activities such as making gifts or loans.

In addition, in the two-party systems as described above, the DRM-based security is associated with a specific and unique terminal, which complicates access for the consumer who must request a new file download when changing terminals.

The distribution systems of the prior art therefore have many disadvantages, both for the distributors and for the consumer who is usually mobile and changes devices fairly regularly.

The object of the invention is to improve the current situation described above.

One of the aims of the invention is to provide the consumer with access to a large number of digital objects, while providing good security and great flexibility in accessing the content of the digital objects.

Another aim of the invention is to propose a new model in the digital object distribution chain.

The object of the present invention is to propose a method and a system for providing at least one digital object in which the three roles: seller (digital library), digital object distributor, and digital object publisher, are clearly distinct and exchange digital objects between them in order to make said digital objects available, without manipulation of said digital objects themselves.

For this purpose, the object of the present invention concerns a method for providing at least one digital object to a user having a first digital media consumption device.

Of course, it is understood that the first digital media consumption device is a multimedia device as described above which is able to read the contents of a digital object.

Advantageously, identification data containing at least one piece of identification information relating to the user of the first digital media consumption device is locally stored on the first digital media consumption device.

In an alternative embodiment of the present invention, this identification data is obtained during an account creation step. Specifically, this step is a step of creating an account with a personal digital library manager, during which the identification data is generated and sent to the first digital media consumption device.

In the invention, the user selects at least one digital object by means of the first digital media consumption device.

This selection is advantageously done over the Internet via a Web interface. Advantageously, this selection is performed directly by the user via a digital library by means of his or her first digital media consumption device.

Advantageously, this digital library comprises a first database storing at least one item of read rights data containing information relating to read rights for the one or more digital object(s). Thus, the one or more digital object(s) are not stored directly in the digital library, but are stored in a third database on a storage server. This storage server is managed by a digital objects distributor, referred to as an e-distributor.

Advantageously, the providing method according to the invention comprises, after this selection, a step of a read rights management server generating personal read rights data. The personal read rights data contains at least one piece of information relating to the read rights for the selected digital object and said at least one piece of identification information relating to the user.

Advantageously, following this generation step, the providing method according to the invention comprises a step of sending the personal read rights data to the personal digital library manager. This sending step is performed by the read rights management server.

Preferably, the personal digital library manager is a remote server providing digital storage using cloud computing technology. Advantageously, said personal digital library manager thus consists of a “library in the cloud.”

In the invention, in order to access the selected digital object, the user connects to the personal digital library manager via the first digital media consumption device. This connection advantageously occurs over the Internet via a Web interface.

Advantageously, the providing method according to the invention comprises, after this connection, a step of authenticating the user by means of the identification data. This authentication step is managed by the personal digital library manager which queries the read rights management server.

Through this series of technical steps that are characteristic of the invention, the invention allows, on the basis of the personal read rights data, providing at least one selected digital object on the first digital media consumption device.

Thus, the underlying principle of the invention consists of using only the data relating to the read rights as the means of exchange between these three abovementioned types of parties; in the invention, these data are now the basis for management, distribution, security, and billing between the parties in the digital objects distribution chain.

After he or she is authenticated using the identification data, the user can access the digital content that he or she has selected; this authentication makes it possible to compare the identification data and the identification information concerning the user that are contained in the personal read rights data.

Advantageously, we distinguish at least two types of exchanges of personal read rights data: one for managing access and security of digital read rights, these exchanges occurring between the personal digital library manager and the read rights management server; and the other for the digital objects themselves, these exchanges occurring between the personal digital library manager, the digital library, and the digital objects distributor.

In an advantageous variant of the invention, the generation step consists of concatenating an item of read rights data, containing information relating to the read rights for the selected digital object, with the identification data. It is understood here that this generation step may advantageously take place in other forms, for example by data aggregation.

Advantageously, the read rights data also contain at least one piece of information relating to the usage rights for the selected digital object.

Advantageously, before the digital object is accessed or downloaded for consumption, the information relating to the usage rights is activated. This consists of an activation step which may, for example, determine the access to the digital object over time on the basis of this information. This activation step may further include activating the file format suitable for the digital media consumption device of the user.

To allow accessing the digital object on another device, the providing method of the invention further comprises a registration step. This registration step, which is executed by the personal digital library manager, consists of registering a second digital media consumption device, using the identification data, to allow providing the selected digital object on the second digital media consumption device.

In an alternative preferred embodiment, the registration step consists of generating and then sending a secret digital certificate to the second digital media consumption device after the second device connects, using the identification data, to the personal digital library manager.

In the invention, the second device stores this secret digital certificate after the next connection, in order to be allowed to access the digital object upon authentication of this certificate by the personal digital library manager. A substantially identical step may also be performed for the first reading device during the account creation step for example.

Correspondingly, the object of the invention relates to a computer program comprising instructions for executing the steps of the providing method as described above, in particular when said computer program is executed by a computer.

Such a computer program may use any programming language, and may be in the form of source code, object code, or an intermediate code between source code and object code such as a partially compiled form, or any other desirable form.

Similarly, the object of the present invention relates to a computer-readable storage medium on which is stored a computer program comprising instructions for executing the steps of the providing method as described above.

The storage medium may be any entity or device capable of storing the program. For example, the medium may comprise a storage means such as ROM memory, for example a CD-ROM or a ROM microelectronic circuit, or a magnetic storage means, for example a diskette (floppy disk) or a hard drive.

Or this storage medium may be a transmission medium such as an electrical or optical signal; such a signal can be conveyed via an electrical or optical cable, by terrestrial or over-the-air radio, or by self-directed laser beam, or by other means. The computer program according to the invention may in particular be downloaded on a network such as the Internet.

Alternatively, the storage medium may be an integrated circuit in which the computer program is embedded, the integrated circuit being adapted to execute or be used in the execution of the method in question.

The object of the invention also relates to the providing system that implements the method described above. More specifically, the object of the invention relates to a system for providing at least one digital object to a user having a first digital media consumption device on which are locally stored identification data, said identification data containing at least one piece of identification information relating to the user.

Advantageously, the providing system according to the invention comprises at least one digital library, a read rights management server, and a personal digital library manager.

Advantageously, the digital library comprises a selection means configured to allow selection of a digital object by means of the first digital media consumption device.

Advantageously, the digital library has a first database storing at least one item of read rights data containing information relating to the read rights for said at least one digital object.

Advantageously, the read rights management server comprises a second database also storing at least one item of read rights data, this item of read rights data containing information relating to the read rights for said at least one digital object.

Advantageously, the read rights data are generated then sent by the digital objects distributor, which itself has a direct connection with the publishers.

Advantageously, the read rights management server further comprises a generation means configured to allow, on the basis of the read rights data for the selected digital object(s), the generation of personal read rights data. These personal read rights data contain at least one piece of information relating to the read rights for the selected digital object and said at least one piece of identification information relating to the user.

In an advantageous embodiment, the generation means is configured to concatenate the read rights data, containing information relating to the read rights for the selected digital object, with the identification data.

Advantageously, the generation means is configured so that the read rights data also contain at least one piece of information relating to the usage rights for the selected digital object.

Advantageously, the read rights management server also comprises a sending means configured to allow sending the personal read rights data to a personal digital library manager.

Advantageously, the personal digital library manager comprises a digital storage means which is configured to receive and store the personal read rights data sent by the read rights management server.

Advantageously, the personal digital library manager further comprises an authentication means which is configured to allow, after connection of the first digital media consumption device to the personal digital library manager, authentication of the user by means of the identification data.

Advantageously, the personal digital library manager also includes an activation means, configured to activate the usage rights for the digital object after authentication of the user.

In a variant embodiment of the invention, the personal digital library manager also comprises an account creation means that is configured to generate and send the identification data to the first digital media consumption device.

Advantageously, the personal digital library manager comprises a registration means which is configured to register, using the identification data, a second digital media consumption device in order to allow providing the selected digital object on the second device.

In a variant embodiment of the invention, the registration means is configured to generate and then send a secret digital certificate to the second digital media consumption device after connection of the second device, using the identification data, to the personal digital library manager.

Thus, the object of the invention, in its various functional and structural aspects, allows providing digital objects while simplifying the exchanges between the different parties in the digital objects distribution chain. The principle of this providing of digital objects is based on exchanges of at least one data item concerning personal read rights for the digital objects selected by the user. Such a data exchange allows consumers to access digital objects without the various constraints encountered in the prior art described above.

It is understood that the model proposed here for providing digital objects according to the invention advantageously allows developing different roles and parties in the digital object production chain while giving the end consumer the freedom to access multiple digital libraries (e-libraries).

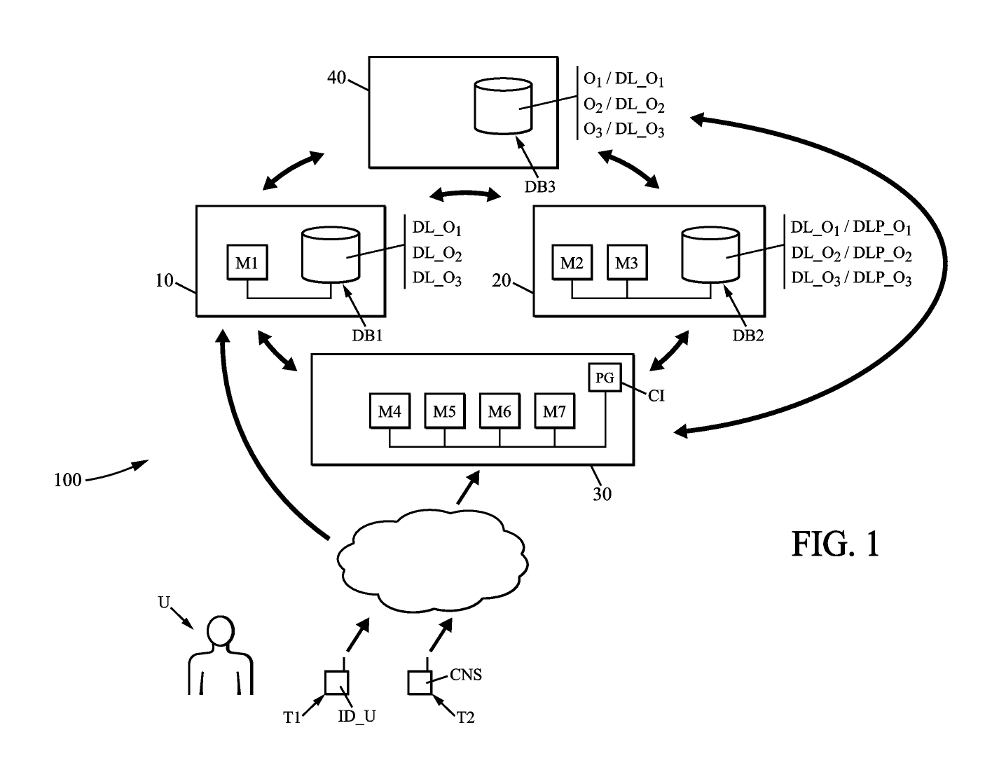

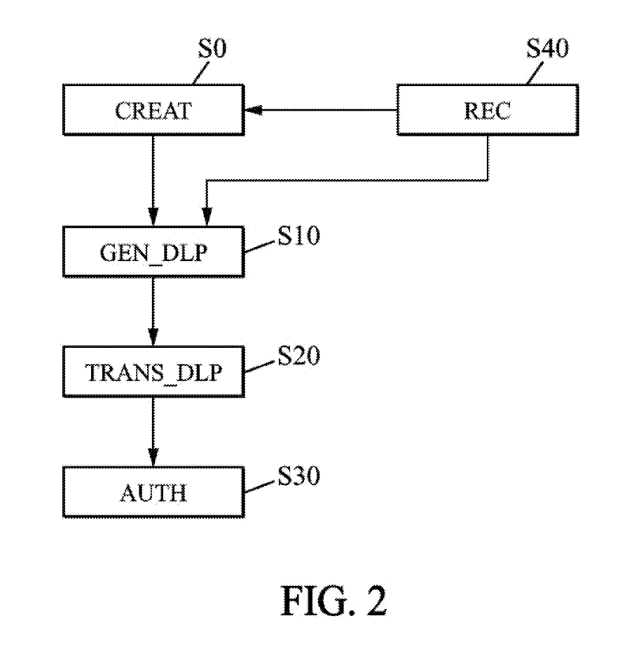

Other features and advantages of the invention will be apparent from the following description, provided with reference to the accompanying FIGS. 1 and 2 which show an embodiment having no limiting character and in which:

FIG. 1 schematically represents a system for providing at least one digital object according to an advantageous exemplary embodiment of the invention; and

FIG. 2 schematically represents a flowchart illustrating the method for providing at least one digital object according to an advantageous exemplary embodiment of the invention.

A system and method for providing at least one digital object, in accordance with an advantageous embodiment of the invention, will now be described with reference to FIGS. 1-2.

As a reminder, one of the aims of the invention is to provide at least one digital object to an end user while avoiding the various disadvantages identified above.

Similarly, another aim of the invention is to expand and enrich the digital object offerings in the digital objects distribution chain while maintaining the security of these objects.

For this purpose, in the example described here and as shown in FIG. 1, the object of the invention relates to a system 100 for providing at least one digital object O1, O2, O3 to a user U having a first digital media consumption device T1.

In the example described herein, the providing system 100 includes at least one digital library 10 (an e-library), a read rights management server 20, and a personal digital library manager 30.

In the example described herein, the providing system 100 also comprises at least one digital objects distributor 40 (an e-distributor).

In the example described herein, the user U has a first digital media consumption device T1 such as a smartphone or laptop. Obviously, any other digital media consumption device can be considered in the context of this invention.

In the example described herein, in an account creation step S0, the user U connects via a Web interface manager to the personal digital library manager 30 in order to create an account. The account is created via an account creation means M5, which generates and sends identification data ID_U to the first digital media consumption device T1, the identification data ID_U containing at least one piece of identification information relating to the user U, such as a customer number for example.

This account creation step SO may take the form of a subscription. It is evident that the first device T1 must be configured to be able to connect to the personal digital library manager 30 and to receive and store the identification data ID_U. Once the user U is registered, he or she can select one or more digital objects O1, O2, O3, these digital objects being for example a video, music, an e-book, or an application.

This selection is characteristic of the present invention.

Indeed, unlike the other systems proposed in the prior art, this selection consists of selecting directly from the digital library 10 at least one digital object O1, O2, O3, using a selection means M1. Characteristically, this selection does not consist of selecting the digital object O1, O2, O3 as such, but consists of only selecting a data item containing information relating to the object O1, O2, O3. As a non-limiting example, such a data item could contain information such as information relating to the title and/or author and/or publication date, and/or relating to an image or any other metadata-type data.

Specifically, in the embodiment described herein, the digital library 10 contains a first database DB1 storing data items which each respectively contain information relating to the digital objects O1, O2, and O3: these identification data are read rights data DL_O1, DL_O2 and DL_O3 that contain information relating to the read rights for the digital objects O1, O2, O3.

These read rights may for example include the following information: {“Puss in Boots”, “Charles Perrault”, “There was a miller whose only inheritance to his three sons [. . . ]”, “1699”, “.pdf” . . . }. These read rights are managed by the e-distributors 40 with the permission of the publishers (not represented here).

The user U therefore selects, via the digital library 10, the read rights data DL_O1, DL_O2 and DL_O3 for the digital object O1, O2, O3 he or she wants, and not the digital object O1, O2, O3 itself.

In other words, in the example described here, the digital library 10 contains the data DL_O1, DL_O2, and DL_O3 which respectively point and refer to the corresponding digital objects O1, O2 and O3; these digital objects O1, O2, O3 are stored at a digital objects distributor 40 which hosts a third database DB3 storing the digital objects O1, O2, and O3 themselves.

This feature allows distinguishing between the roles of the various parties in the digital objects distribution chain.

It is further understood that, because of this distinction between the various roles and because of this type of data exchange, it is possible to have multiple digital libraries and multiple digital objects distributors, which broadens and enriches the offerings to end consumers.

For clarity, the embodiment described herein is limited to one digital library 10 and one digital distributor 40.

To the user, the e-libraries 10 are the visible aspects of the system. Each library has a catalog of digital objects O1, O2, O3, containing metadata from the read rights.

Optionally (not represented here), the providing method according to the invention may comprise, after this selection, a request to confirm the selection, for example to verify the selection before the final purchase.

In the example described here, the read rights management server 10 includes a second database DB2 which also stores read rights data DL_O1, DL_O2 and DL_O3 which each contain information relating to the read rights for the digital objects O1, O2, and O3.

As mentioned above, the first DB1 and second DB2 databases are provided and supplied data by the digital objects distributor 40.

After the selection described above and the request confirmation if any, the read rights management server 10 generates, in a generation step S10 and by means of a generation means M2, personal read rights data DLP_O1, DLP_O2, DLP_O3 on the basis of the read rights data DL_O1, DL_O2, DL_O3 for the selected digital object(s) O1, O2, O3.

In the example described here, the personal read rights data DLP_O1, DLP_O2, DLP_O3 contain information relating to read rights for the selected digital object O1, O2, O3, identification information relating to the user U, and information relating to usage rights for the selected digital object O1, O2, O3.

In other words, when a user U selects and buys a digital object O1, O2 and/or O3, the read rights data DL_O1, DL_O2, DL_O3 become personal, and are supplemented with at least the information relating to the user and the purchase/selection.

For example, the information relating to the usage rights for the selected digital object O1, O2, O3 can be information such as, for example, the usage period for the digital object, the purchase date of the digital object, etc.

The information relating to the read rights for the selected digital object can be information such as, for example, the available formats of the digital object, commercial information such as price, or information concerning the work itself such as, for example, the title, author, songwriter, etc.

In the exemplary embodiment described, the personal read rights data DLP_O1, DLP_O2, DLP_O3 consist of the read rights data DL_O1, DL_O2, DL_O3 to which is added the information mentioned above, by concatenation or aggregation of the corresponding data.

As a general example, the data referred to as “DLP” (droits de lecture personnel, or Personal Read Rights) is in the following form:

DLP=read rights+{“library X”, “date of purchase=18 NOV. 2011”, “usage rights=Y”}.

In the example described here, the read rights management server 20 includes a sending means M3 that allows, during a sending step S20, the sending of this personal read rights data DLP_O1, DLP_O2, DLP_O3 to the personal digital library manager 30.

The personal digital library manager 30 then manages the life of the selected digital objects: classification, creation of lists of objects, viewing the objects on various compatible terminals, etc.

In the exemplary embodiment described herein, the personal digital library manager 30 comprises a digital storage means M7 which is specially configured for receiving and storing the personal read rights data DLP_O1, DLP_O2, DLP_O3 sent in this manner.

Thus, through this series of technical steps, the personal digital library manager 30 contains one or more pieces of personal read rights data DLP_O, DLP_O2, DLP_O3 each corresponding to the different digital objects O1, O2 and/or O3 selected by the user U.

Based on these personal read rights data DLP_O1, DLP_O2, DLP_O3, the personal digital library manager 30 retrieves, from the e-distributor 40, the ad hoc files that are necessary for the user to be able to manipulate the selected objects O1, O2, O3 and that are compatible with the devices T1 and the media consumption software of the user.

Allowing flexible access to the contents of the selected digital object(s) is one of the aims of the invention. Also, the invention provides for the possibility of the user U accessing the digital objects O1, O2, O3 from several types of terminals.

For this purpose, the personal digital library manager 30 also includes a registration means M6 which allows the user U in a registration step S40 to register, using the identification data ID_U, a second digital media consumption device T2. In the example described here, this registration consists of generating and then sending a secret digital certificate SDC to the second digital media consumption device T2.

This digital certificate SDC may be a software certificate.

As mentioned above, the registration step S40 can also be performed for the first device T1 after the account creation step. In this case, a digital certificate is also stored on the first device T1.

One of the aims of the invention is to allow access via a personal digital library manager 30 to the content of the digital object(s) O1, O2, O3.

Also, after a connection of the first T1 or second T2 digital media consumption device to the personal digital library manager 30, said manager 30 comprises an authentication means M4 which allows authentication of the user U in an authentication step S30, this authentication occurring by means of the identification data ID_U and/or the digital certificate SDC.

Optionally (not represented here), the digital library is updated after this authentication: this update processes the read rights that have been acquired, lost, or have expired since the previous connection.

The authentication then triggers a phase of activating the usage rights (not represented here). This activation phase facilitates the purchase of gifts: it is possible to have the usage rights activated not at the time of purchase, but when first viewed or played, which allows the creation of time-limited offers for example.

After this activation, the providing method may also include a supplemental security phase during which a layer of DRM-based security is added.

Once these authentication, activation, and security phases are completed, the user can access the digital objects O1, O2, O3 he or she has selected, on the basis of course of the user's personal read rights data DLP_O1, DLP_O2, DLP_O3.

The selected digital object(s) O1, O2, O3 may be provided by downloading for example or by streaming for example interchangeably.

This series of technical steps is managed by a computer program PG, comprising instructions suitable for executing the steps of the providing method, which is contained on a storage medium CI.

Thus, the system 100 for providing digital objects according to the invention proposes an open model with at least three parties, such that each party (publisher, e-distributors, e-libraries, rights management server) focuses on its role in order to enrich the digital object offerings and to allow simpler and more flexible access to the digital objects.

It should be observed that this detailed description concerns a specific embodiment of the invention, but in no way does this description have any limiting character regarding the object of the invention; rather, it is intended to eliminate any ambiguities or any misinterpretations of the following claims.

1. A method for providing at least one digital object to a user having a first digital media consumption device on which is locally stored identification data containing at least one piece of identification information relating to the user, the providing method comprising:
after selection, by means of the first digital media consumption device (T1), of a digital object in a digital library, a step of a read rights management server generating personal read rights data containing at least one piece of information relating to the read rights for the selected digital object and said at least one piece of identification information relating to the user,
a step of sending the personal read rights data to a personal digital library manager, and
after a connection of the first digital media consumption device to the personal digital library manager, a step of authenticating the user by means of the identification data,
so as to allow, on the basis of said personal read rights data, providing the selected digital object on the first digital media consumption device.

2. The providing method according to claim 1, comprising a step of creating an account with the personal digital library manager, during which the identification data is generated and sent to the first digital media consumption device.

3. The providing method according to claim 1, wherein the generation step consists in particular of concatenating an item of read rights data, containing information relating to the read rights for the selected digital object, with the identification data.

4. The providing method according to claim 1, wherein the personal read rights data contain at least one piece of information relating to the usage rights for the selected digital object.

5. The providing method according to claim 1, comprising a registration step consisting in particular of registering a second digital media consumption device, using the identification data (ID U), to allow providing the selected digital object on said second digital media consumption device.

6. The providing method according to claim 5, wherein the registration step consists of generating and then sending a secret digital certificate to the second digital media consumption device after said second device connects, using the identification data, to the personal digital library manager.

7. A non-transitory computer-readable storage medium comprising a computer program comprising instructions for executing the steps of the providing method according to claim 1 when said computer program is executed by a computer.

8. (canceled)

9. A system for providing at least one digital object to a user having a first digital media consumption device on which are locally stored identification data containing at least one piece of identification information relating to the user, said providing system comprising at least one digital library, a read rights management server, and a personal digital library manager,
said at least one digital library comprising:
a) a selection means configured to allow selection of at least one digital object by means of the first digital media consumption device,
the read rights management server comprising:
b) a second database storing at least one item of read rights data containing information relating to the read rights for said at least one digital object,
c) generation means configured to allow, on the basis of the read rights data for said at least one selected digital object, the generation of personal read rights data containing at least one piece of information relating to the read rights for the selected digital object and said at least one piece of identification information relating to the user, and
d) a sending means configured to allow sending the personal read rights data to the personal digital library manager, and
the personal digital library manager comprising an authentication means configured to allow, after connection of the first digital media consumption device to the personal digital library manager, authentication of the user by means of the identification data,
so as to allow, on the basis of the personal read rights data, providing said at least one selected digital object on the first digital media consumption device.

10. The providing system according to claim 9, wherein the personal digital library manager comprises an account creation means configured to generate and send the identification data to the first digital media consumption device.

11. The providing system according to claim 9, wherein the generation means is configured to concatenate the read rights data, containing information relating to the read rights for the selected digital object, with the identification data.

12. The providing system according to claim 9, wherein the generation means is configured so that the personal read rights data contain at least one piece of information relating to the usage rights for the selected digital object.

13. The providing system according to claim 9, wherein the personal digital library manager comprises a registration means configured to register, using the identification data, a second digital media consumption device in order to allow providing the selected digital object on said second device.

14. The providing system according to claim 13, wherein the registration means is configured to generate and then send a secret digital certificate to the second digital media consumption device after connection of said second device, using the identification data, to the personal digital library manager.

15. The providing system according to claim 9, wherein the personal digital library manager comprises a digital storage means configured to receive and store the personal read rights data sent by the read rights management server.
